(19) United States
(12) Patent Application Publication
(10) Pub. No.: US 2008/0068330 A1
(43) Pub. Date: Mar. 20, 2008

(54) Liquid crystal display unit and liquid crystal television

(75) Inventor: Takayoshi Urisu, Osaka (JP)

Correspondence Address: Yokoi & Co., U.S.A., Inc., 13700 Marina Pointe Drive #723, Marina Del Rey, CA, 90292, US

(73) Assignee: Funai Electric Co., Ltd., Osaka (JP)

(21) Appl. No.: 11/901,358

(22) Filed: Sep. 17, 2007

(30) Foreign Application Priority Data
Sep. 19, 2006 (JP) JP2006-252696
Jul. 25, 2007 (JP) JP2007-193320

(51) Int. Cl. G09G 3/36

(52) U.S. Cl. 345/102

(57) ABSTRACT

A microcomputer 15 refers to the luminance stabilizing program and the look-up table stored in the ROM 16 to allow the video circuit 12 to execute a contrast adjustment of the video signal based on the look-up table such that the luminance change of the liquid crystal display unit 13 in the initial drive stage is kept constant. This makes it possible to correct the luminance change of the liquid crystal display unit 13 in the initial drive stage with the simple structure.

### CROSS-REFERENCES TO RELATED APPLICATIONS

The present application is related to the Japanese Patent Application No. 2006-252696, filed Sep. 19, 2006 and the Japanese Patent Application No. 2007-193320, filed Jul. 25, 2007, the entire disclosure of which is expressly incorporated by reference herein.

### BACKGROUND OF THE INVENTION

1. Field of the invention

The present invention relates to a liquid crystal display unit structured to correct the screen luminance, and more particularly, to a liquid crystal display unit for correcting the luminance which varies with a panel characteristic of the liquid crystal display unit especially equipped with a backlight, and a liquid crystal television.

2. Description of the Related Art

FIG. 2 is a view representing the screen luminance in the state after an elapse of a predetermined time period from turning the power ON.

Referring to the drawing, the luminance of a video image displayed on the screen increases for a predetermined period of time, forming a gentle curve from the state where the power is ON in the initial drive stage. The luminance gradually reduces thereafter to converge on the constant value. On the screen, the luminance is gradually decreased to be dark to make the user or viewer feel uneasy. It is well known that the luminance change after turning the power ON as described above depends on the temperature characteristic between cold cathodes for the backlight, and the temperature characteristic of the sheet (especially the lens sheet) in the optical system used within the liquid display unit.

FIG. 9 is a perspective view showing the inside of the generally employed backlight.

Referring to the drawing, a backlight I includes a cold cathode 2 for irradiating light as a light source, a lamp reflector 3 for reflecting the light from the cold cathode 2 toward one direction, a light guide plate 4 for irradiating the light from the cold cathode 2 to the front surface at the side of the liquid crystal display unit, a diffusion sheet 5 for diffusing the light irradiated from the light guide plate 4, and a lens sheet 6 which focuses the light diffused by the diffusion sheet 5 on the side of the liquid crystal display unit.

In the aforementioned structure, the light irradiated from the cold cathode 2 is reflected to the whole surface at the liquid crystal display unit via the light guide plate 4 so as to be irradiated. The light from the light guide plate 4 is focused onto the liquid crystal display unit by the diffusion sheet 5 and the lens sheet 6, resulting in the uniform light irradiation.

The lens sheet 6 formed of an acrylic resin material has the converging level variable depending on the temperature. The luminance value of the light irradiated to the liquid crystal display unit varies until the temperature of the lens sheet 6 is stabilized to be constant. The luminance value of the light irradiated by the backlight 1 varies owing to another luminance characteristic depending on the temperature of the cold cathode 2. Accordingly, the liquid crystal display unit has the luminance in the initial drive stage varied as shown in FIG. 2.

The following method for correcting the luminance of the liquid crystal display unit with the white LED backlight has been disclosed for the purpose of solving the aforementioned problem with respect to the luminance change. Japanese Unexamined Patent Application Publication No. 2005-345552 (hereinafter referred to as Patent Document 1) discloses the correction of the backlight luminance value by the timing correction unit for adjusting the timing for setting the backlight luminance value which executes the feedback control of the backlight illumination using the LED drive circuit in response to the change in the transmissivity of the liquid crystal display unit.

Alternatively, the following method for correcting the luminance of the liquid crystal display using the luminance controller equipped with the optical sensor having the error range differed at the individual level has been disclosed. That is, Japanese Unexamined Patent Application Publication No. 2002-297103 (hereinafter referred to as Patent Document 2) discloses the correction of the luminance of the LCD backlight panel by forming a range table showing the correlation between the environmental luminance and the luminance of the liquid crystal display unit.

The method for keeping the constant luminance of the liquid crystal display unit of field sequential type with no color filter under various temperature conditions has been disclosed as follows. That is, Japanese Unexamined Patent Application Publication No. 2001-272956 (hereinafter referred to as Patent Document 3) discloses establishment of desired color expression by changing the time-integral value of the luminance of the light source based on the temperature information and the maximum transmissivity information of the liquid crystal element.

The backlight disclosed in Patent Document 1 is equipped with the white LED as the lamp, which cannot be replaced by the one equipped with the cold cathode. The disclosed art is intended to adjust the luminance of the liquid crystal display unit on the basis of the normal use, and is not intended to be used for correcting the luminance change of the liquid crystal display unit in the initial drive stage as in the present invention.

The art disclosed in Patent Document 2 is intended for correcting the error range of the optical sensor for correcting the liquid crystal display luminance using the corresponding range table. It is, therefore is not intended for correcting the luminance change of the liquid crystal display unit in the initial drive stage as in the present invention.

The art disclosed in Patent Document 3 is intended for allowing the liquid crystal display unit of field sequential type with no color filter to establish the desired color representation under various temperature conditions through correction, and is not intended for correcting the luminance change of the liquid crystal display unit in the initial drive stage.

### BRIEF SUMMARY OF THE INVENTION

The present invention provides a liquid crystal display unit capable of correcting the luminance change of the liquid crystal display unit in the initial drive stage with a simple structure, and a liquid crystal television using the liquid crystal display unit.

A liquid crystal display unit according to the present invention includes a backlight provided with a cold cathode for displaying a video image by changing a transmissivity of a light source from the backlight, and a video signal processing unit that performs an image quality adjustment of the video image displayed thereon. The liquid crystal display unit further includes a temperature measurement unit that measures a temperature around a screen of the liquid crystal display unit, a time count unit that counts a time cumulatively from a moment when the liquid crystal display unit is turned ON, a time-luminance correlation memory section that stores a luminance value of the liquid crystal display unit corresponding to a cumulative time counted from a moment when the liquid crystal display unit is turned ON at each temperature around the screen of the liquid crystal display unit, and a liquid crystal display luminance correction unit that commands the video signal processing unit to correct a luminance of the liquid crystal display unit in reference to a record in the time-luminance correlation memory section based on the measured temperature and the counted cumulative time.

In the above-structured liquid crystal display unit, the liquid crystal display luminance correction unit commands the video signal processing unit to correct the luminance of the liquid crystal display unit in reference to the record in the time-luminance correlation memory section based on the measured temperature and the counted cumulative time. This makes it possible to correct the luminance change of the liquid crystal display unit in the initial drive stage with the simple structure using the time-luminance correlation memory section.

As specific example of the structure for correcting the luminance of the liquid crystal display, the video signal processing unit is structured to control the contrast of the video image displayed on the liquid crystal display unit. The liquid crystal display luminance correction unit may be structured to command the video signal processing unit to control the contrast corresponding to the counted time in reference to the time-luminance correlation memory section.

In the above-structured invention, the luminance of the liquid crystal display unit in the initial drive stage is corrected under the contrast control executed by the video signal processing unit. As the video signal processing unit has been generally employed, the subject luminance correction may be realized with the simple structure without using an extra process.

The aforementioned process for correcting the luminance of the liquid crystal display unit is not limited to the one for correcting the input video signal. As another specific example for correcting the luminance of the liquid crystal display unit, a liquid crystal display unit that includes a backlight provided with a cold cathode, a liquid crystal display unit that displays a video image by changing a transmissivity of a light source from the backlight, and a backlight drive unit for generating a tube current to drive the backlight is provided. The liquid crystal display unit further includes a temperature measurement unit that measures a temperature around a screen of the liquid crystal display unit, a time count unit that counts a time cumulatively from a moment when the liquid crystal display unit is turned ON, a time-luminance correlation memory section that stores a luminance value of the liquid crystal display unit corresponding to a cumulative time from a moment when the liquid crystal display is turned ON at each temperature around the screen of the liquid crystal display unit, a tube current adjustment unit for controlling a value of the tube current output from the backlight drive unit to the backlight, and a liquid crystal display luminance correction unit that outputs the tube current value to be output to the backlight to the tube current adjustment unit in reference to a record in the time-luminance correlation memory section based on the measured temperature and the counted cumulative time.

In the aforementioned structure, the liquid crystal display luminance correction unit commands the tube current adjusting unit to correct the luminance in reference to the record in the time-luminance correlation memory section based on the measured temperature and the counted cumulative time. The tube current adjusting unit adjusts the tube current based on the command issued by the liquid crystal display luminance correction unit to adjust the backlight luminance. The aforementioned correction process allows the luminance correction of the liquid crystal display unit without subjecting the video signal to the signal processing, thus preventing degradation of the video signal due to the correction.

In the case where the liquid crystal display unit is structured to execute the control using the microcomputer based on the input command, the microcomputer may be exemplified as the liquid crystal display luminance correction unit.

The aforementioned structure allows the liquid crystal display luminance correction unit to be realized as the existing microcomputer.

The time-luminance correlation memory section may be formed as the look-up table referred by the microcomputer.

The time-luminance relation memory section formed as the look-up table to be stored as the data referred by the microcomputer provides the effect of the present invention with the simple structure.

As a specific structure for solving the aforementioned problems, a liquid crystal television includes a backlight provided with a cold cathode, a liquid crystal display unit that displays a video image by changing a transmissivity of a light source from the backlight, a video circuit that performs a contrast adjustment with respect to a video signal to be input, a microcomputer that executes an entire control upon reception of an operation through a remote controller, a ROM that stores a program and a table, based on which the microcomputer is activated, a temperature sensor that measures a temperature around a screen of the liquid crystal display unit, and a time count unit that counts a time cumulatively from a moment when the liquid crystal display unit is turned ON. The ROM stores a look-up table that records a luminance value of the liquid crystal display unit corresponding to a cumulative time from a moment when the liquid crystal display unit is turned ON at a predetermined temperature around the screen of the liquid crystal display unit, and a luminance correction program that allows the microcomputer to command the video circuit to correct a contrast for correcting a luminance of the video image displayed on the liquid crystal display unit in an initial drive stage thereof in reference to the luminance value stored in the look-up table corresponding to the temperature of the liquid crystal display unit measured by the temperature sensor.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding parts throughout:

FIG. 1 is an exemplary illustration of a block diagram of a liquid crystal television.

FIG. 2 is an exemplary illustration of a luminance-time characteristic chart showing the luminance change at the respective temperatures.

FIG. 3 is an exemplary illustration of a time-luminance correlation chart showing the luminance correction executed by the video circuit based on the look-up table.

FIG. 4 is an exemplary illustration of a time-luminance correlation chart showing the luminance after the correction.

FIG. 5 is an exemplary illustration of a flowchart showing the routine for stabilizing the luminance.

FIG. 6 is an exemplary illustration of a block diagram of a liquid crystal television 10 according to a second embodiment.

FIG. 7 is an exemplary illustration of a block diagram showing a structure of an exemplary power supply circuit.

FIG. 8 is an exemplary illustration of a flowchart showing the luminance stabilizing program according to the second embodiment.

FIG. 9 is an exemplary illustration of a perspective view showing the inside of the generally employed backlight.

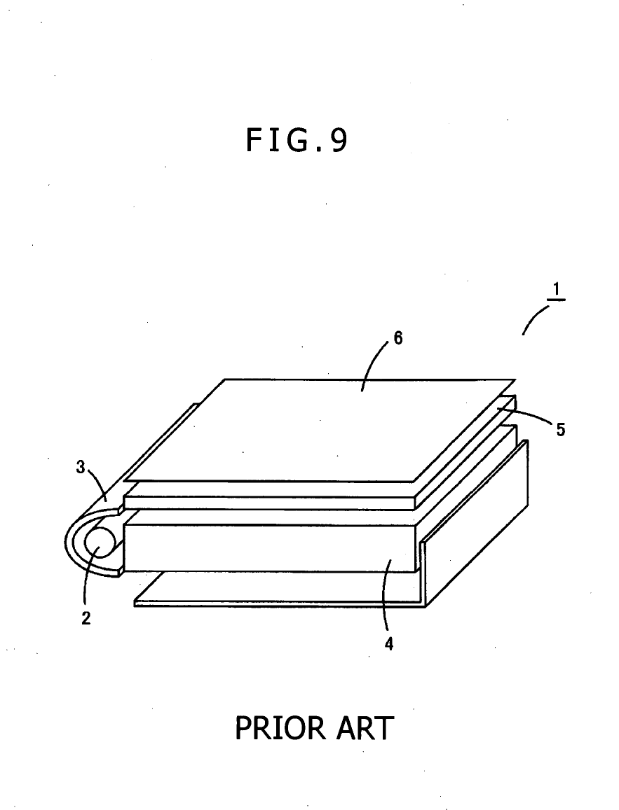

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

A liquid crystal television that employs the aforementioned liquid crystal display unit will be described as the specific example of the liquid crystal display unit according to the present invention. The embodiments of the present invention will be described in sections in the order as described below
(1) First embodiment

(1-1) Liquid crystal television structure

(1-2) Luminance correction process in the initial drive stage
(2) Summary of the first embodiment
(3) Second embodiment
(4) Summary of the second embodiment

### (1) First Embodiment

(1-1) Liquid Crystal Television Structure

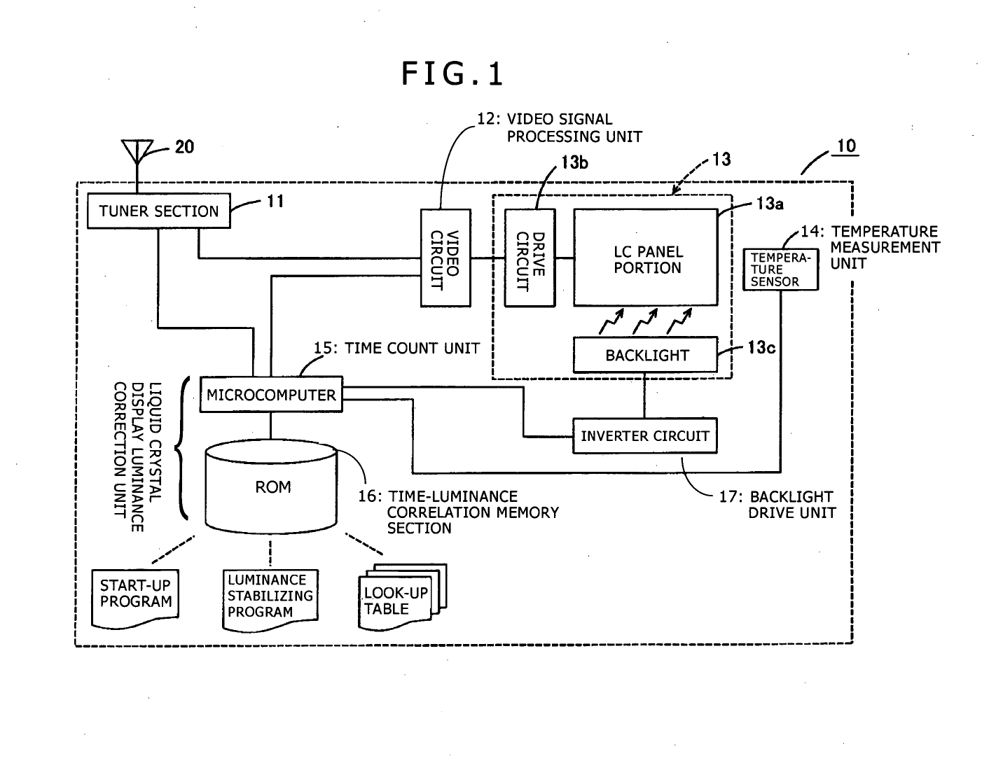

A first embodiment as the exemplary liquid crystal television according to the present invention will be described referring to FIGS. 1 to 5.

FIG. 1 is a block diagram of a liquid crystal television. A liquid crystal television 10 displays a video image based on a video signal such as an input television signal. The liquid crystal television 10 is formed of a tuner section 11 for extracting predetermined video signals and voice signals from the television broadcast received by an antenna 20, an video circuit 12 (video signal processing unit) which subjects the video signal received by the tuner section 11 to a predetermined signal processing, a liquid crystal display unit 13 which displays the video image based on the video signal from the video circuit 12, a microcomputer 15 which entirely controls the liquid crystal television 10, a ROM 16 which stores the program and the table (time-luminance correlation memory section) for activating the microcomputer 15, a temperature sensor 14 (temperature measurement unit) which measures the temperature of the liquid crystal display unit 13, and an inverter circuit 17 which supplies power to the backlight of the liquid crystal display unit 13.

In the aforementioned structure, the television broadcast received by the antenna 20 is input to the tuner section 11 which extracts the video and voice signals corresponding to the predetermined broadcast. Based on the video signal extracted by the tuner section 11, the video circuit 12 generates video data which form the screen. The generated video data contain the luminance signal Y, and luminance/color difference signals (R-Y, B-Y) each as the difference between the Y signal representing the luminance signal and R, G signals as color signals among RGB, respectively. The video circuit 12 generates the RGB color signals, respectively from the input luminance signal and the luminance/color difference signals, and further generates the pixel signals corresponding to pixels arrayed in matrix on the liquid crystal display unit 13. Specifically, in case of the liquid crystal display unit 13 of VGA, that is, 640×480, a pixel signal is formed by equally segmenting the video data which constitute one screen into 640×480. In case of XGA, that is, 1024×768, the pixel signal is formed by equally segmenting the video data into 1024×768.

The video circuit 12 subjects the thus segmented data to the predetermined signal processing so as to be output to the liquid crystal display unit 13. For example, the contrast adjustment for adjusting the white or black level of the image signal, gamma correction corresponding to the display characteristic of the liquid crystal display unit 13 as the signal processing may be performed by the video circuit 12. As the contrast adjustment and the gamma correction have been well known, the explanation of the process will be omitted. The aforementioned signal processing may be automatically executed based on the color signal of the difference signals (R-Y, B-Y), and the luminance signal Y Alternatively, such processing may further be performed by the microcomputer 15 upon reception of the user's operation through the remote controller.

The video data subjected to the signal processing by the video circuit 12 are output to the liquid crystal display unit 13. The liquid crystal display unit 13 includes a liquid crystal panel portion 13a formed of pixels provided with color filters of RGB arrayed in matrix, a drive circuit 13b that converts the video data input from the video circuit 12 into analog signals so as to be applied to the respective pixels of the liquid crystal panel portion 13a, and a backlight 13c disposed at the back surface of the liquid crystal panel portion 13a for irradiating the light source. In the aforementioned structure, the video data output from the video circuit 12 are converted into the analog signals at the predetermined voltage through the drive circuit 13b so as to be applied to the respective pixels of the liquid crystal panel portion 13a arrayed in the matrix. The molecular arrangement of the liquid crystal substance filled by each pixel is changed to display the video image.

The backlight 13c is disposed at the back surface of the screen of the liquid crystal display unit 13 such that the light source from the backlight 13c is irradiated to the liquid crystal panel portion 13a. Each pixel of the liquid crystal panel portion 13a which receives the light from the backlight 13c serves to change the transmissivity of the light between the pixels under the voltage applied from the drive circuit 13b. As a result, the tone between the pixels varies to display the image on the screen of the liquid crystal display unit 13. The backlight 13c in the embodiment of the present invention employs the cold cathode as a lamp. The cold cathode may be a U-tube or the one similar thereto. The shape of the tube may be selected in accordance with the specification of the liquid crystal display unit 13.

In the aforementioned structure, the liquid crystal television 10 displays the video image on the liquid crystal display unit 13. However, the luminance changes in the initial drive stage of the liquid crystal display unit 13. The viewer may be misled to take the luminance change for the failure in the liquid crystal television 10, thus making the viewer feel discomfort. The liquid crystal television 10 according to the present invention is structured to automatically correct the luminance change in the initial drive stage so as to alleviate the discomfort felt by the viewer. In the liquid crystal television 10 according to the present invention, the ROM 16 stores the look-up table which allows the microcomputer 15 to issue the command to correct the luminance based on the temperature of the liquid crystal display unit 13 measured by the temperature sensor 14. The microcomputer 15 consequently is allowed to count the time from turning the power ON in the cumulative manner. In view of the aforementioned aspect, the microcomputer 15 forms the time count unit. The microcomputer 15 and the ROM 16 form the liquid crystal display luminance correction unit, the specific structure of which will be described hereinafter.

(1-2) Luminance Correction Process in the Initial Drive Stage

The degree of the luminance change of the liquid crystal display unit 13 in the initial drive state varies depending on the temperature characteristics of the cold cathode which forms the backlight 13c and the lens sheet. Accordingly, the liquid crystal television 10 allows the temperature sensor 14 to measure the temperature around the liquid crystal display unit 13, based on which the luminance of the liquid crystal display 13 is corrected.

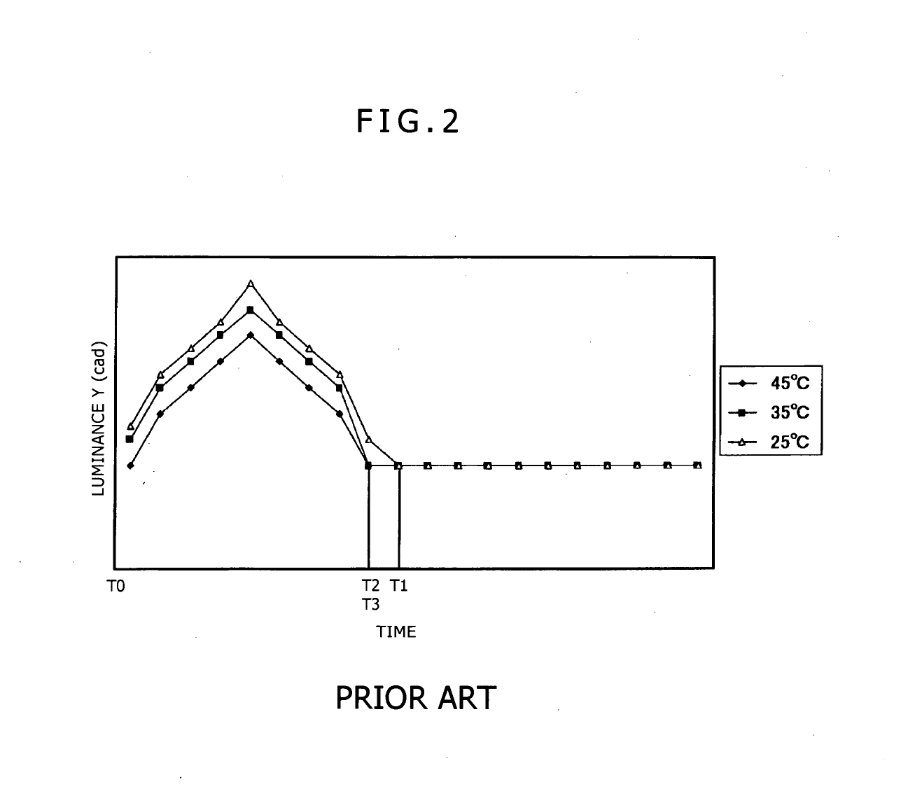

FIG. 2 is a luminance-time characteristic chart representing how the luminance changes at the respective temperatures. FIG. 2 shows each luminance change at temperatures of the liquid crystal display unit 13, that is, 25°, 35° and 45°, respectively. Referring to FIG. 2, in an arbitrary case at 25°, 35° or 45°, the luminance Y first increases from the time when the power is turned ON to the time T1 (25°), T2 (35°), and T3 (45°), and then decreases to form a gentle curve as a whole. The luminance Y is converted into the saturated luminance Ym through inverse correction for the purpose of suppressing the luminance change for the period until the time T1, T2 and T3, respectively.

In the first embodiment of the present invention, the luminance change in the initial drive stage is corrected through the contrast adjustment function of the video circuit 12. Specifically, the values of the video data are changed through the contrast adjustment such that each change in the luminance for the period from the time T0 to the time T1, T2, T3 becomes equal to the saturated luminance value Ym through the inverse correction. For this, the ROM 16 stores the look-up table and the luminance correction program for the microcomputer 15 to perform the contrast adjustment corresponding to the temperature measured by the temperature sensor 14 so as to prevent the luminance change in the initial drive stage through the contrast adjustment executed by the video circuit 12.

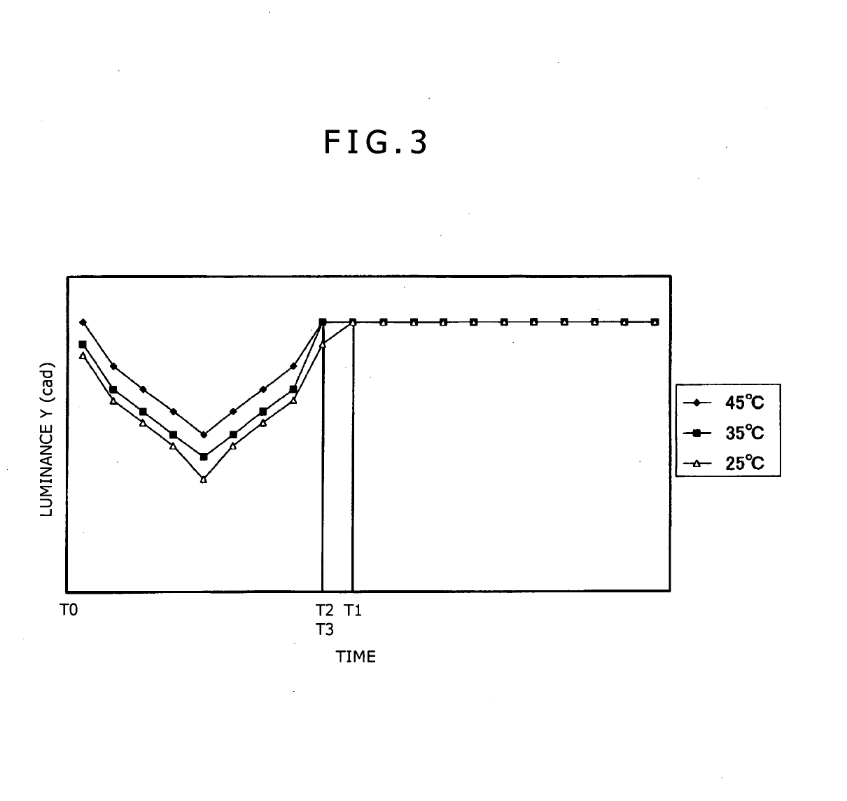

FIG. 3 is a time-luminance correlation chart showing the luminance correction executed by the video circuit 12 based on the look-up table, where the target luminance Y is set by the video circuit 12, taking no consideration for the influence of the temperature.

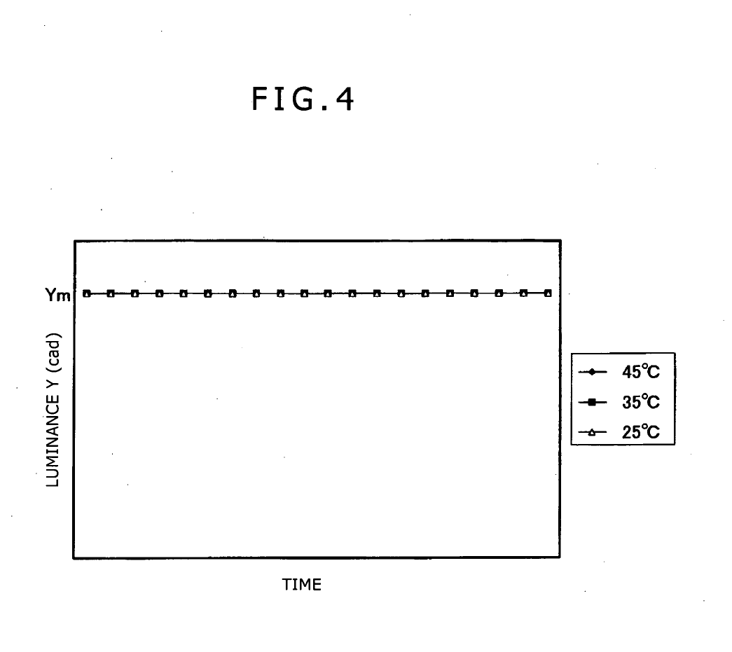

FIG. 4 is a time-luminance correlation chart showing the actual values of the luminance after the correction. In all the cases at the temperatures 25°, 35° and 45°, the luminance becomes the constant saturated luminance value Ym irrespective of the cumulative time period.

Referring to FIG. 3, the contrast adjustment executed for the period from the time T0 to the time T1, T2 and T3, respectively realizes the constant saturated luminance Ym displayed on the liquid crystal display unit 13 as shown in FIG. 4. Specifically, the contrast adjustment is performed by preliminarily subtracting the amount of change in the luminance corresponding to the temperature characteristic of the liquid crystal display unit 13 from the luminance of the video data. This allows the luminance displayed on the liquid crystal display unit 13 based on the video data will become the saturated luminance Ym irrespective of the temperature. Upon the contrast adjustment, the video signal is subjected to the white level correction or black level correction for each signal processing of the color signals of RGB. The luminance, thus, is not directly corrected. However, the luminance Y may be calculated in correlation with the color signals of RGB using the following formula:
Y=0.30R+0.59G+0.11B (1).
The value for correcting the luminance shown in FIG. 3 may be generated using the color signals of RGB.

The luminance of the video data after the correction reaches the value around the saturated luminance Ym as shown in FIG. 4 through the aforementioned contrast adjustment. The microcomputer 15 commands the video circuit 12 to subject the video data to the contrast adjustment corresponding to the aforementioned look-up table so as to correct the luminance change of the video image displayed on the liquid crystal display unit 13 in the initial drive stage.

The microcomputer 15 executes the luminance correction based on the luminance stabilizing program stored in the ROM 16. The luminance stabilizing program to be executed by the microcomputer 15 will be described referring to the flowchart.

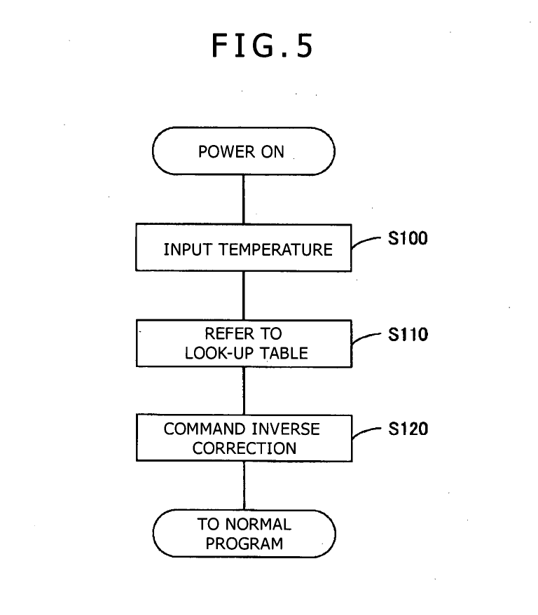

FIG. 5 is a flowchart of the luminance stabilizing program. When the power is turned ON upon the operation through the remote controller to supply power to the liquid crystal display unit 13, the microcomputer 15 makes the transition from executing the normal program to the luminance stabilizing program referred in the ROM 16.

The microcomputer 15 inputs the data of the temperature around the liquid crystal display unit 13 which have been output from the temperature sensor 14 (step S100). The temperature value detected by the temperature sensor 14 may be varied in accordance with the luminance characteristic of the liquid crystal display.

The microcomputer 15 then refers to the look-up table stored in the ROM 16 (step S110), specifically, the value for the contrast process corresponding to the temperature input from the temperature sensor 14. In this case, the microcomputer 15 counts the time cumulatively from the moment when the power is turned ON, and refers to the value for the contrast process corresponding to the counted cumulative time.

If the table where the correction value for the luminance at the temperature corresponding to the signal input from the temperature sensor 14 is correlated with the address recorded at the respective time is preliminarily stored in the ROM 16, the microcomputer 15 is allowed to refer to the look-up table easily. The microcomputer 15 commands the video circuit 12 to execute the contrast process with respect to the input video data based on the referred contrast process value (S120). The video circuit 12 then executes the contrast process with respect to the input video data in response to the command of the microcomputer 15.

### (2) Summary of the First Embodiment

As described above, the liquid crystal television 10 corrects the luminance change of the liquid crystal display unit 13 in the initial stage through the contrast process executed by the video circuit 12 in response to the command of the microcomputer 15. This makes it possible to alleviate the discomfort felt by the viewer by correcting the luminance change of the liquid crystal display unit 13 in the initial drive stage through the contrast process executed by the video circuit 12. An additional circuit for correcting the luminance in not required, thus allowing the luminance correction with the simple structure.

### (3) Second Embodiment

In the first embodiment as described above, the contrast process is executed by the video circuit 12 to correct the luminance change in the initial drive stage. However, the process for correcting the luminance is not limited to the correction of the video data by the video circuit 12 as described above, but the process for correcting the luminance of the light source irradiated from the backlight 13c may be employed. The second embodiment according to the present invention is structured to perform the inverse correction of the luminance of the liquid crystal display unit 13 by controlling the tube current value applied to the backlight 13c.

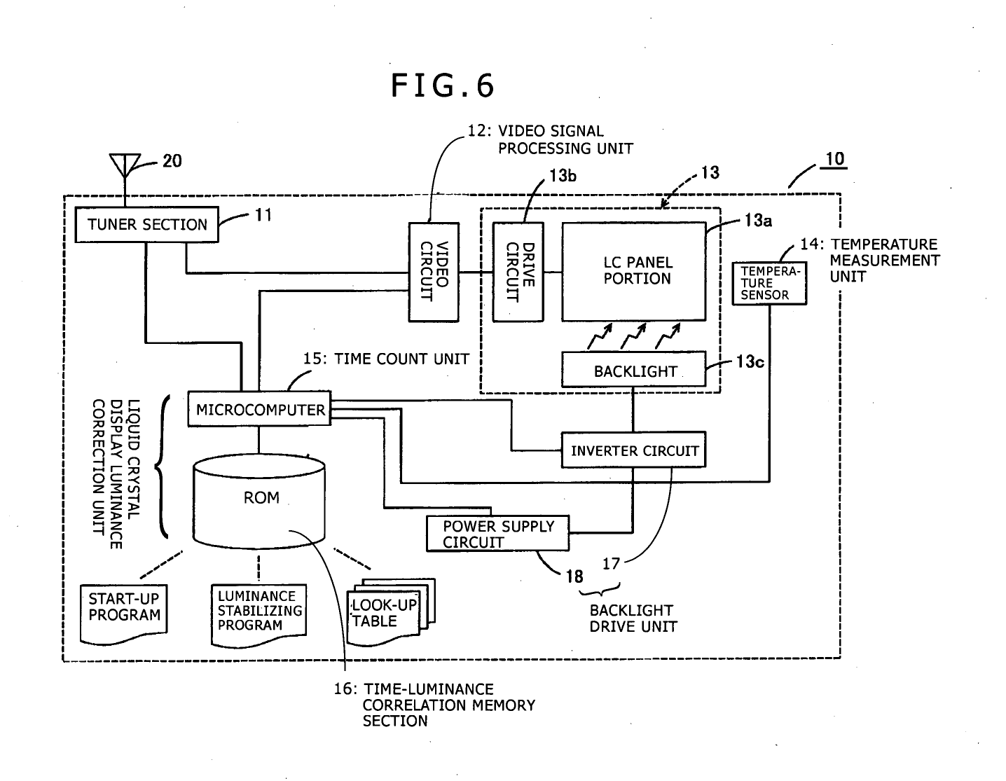

FIG. 6 is a block diagram of the liquid crystal television 10 according to the second embodiment. Referring to the drawing, the block with the same code as the one shown in FIG. 1 has the same structure. The liquid crystal television 10 includes a power supply circuit 18 for generating stabilizing power from the commercial power supply, and an inverter circuit 17 (backlight drive unit) for driving a plurality of cold cathodes 13c1 based on the power from the power supply circuit 18 so as to drive the backlight 13c. The aforementioned power supply circuit 18 is connected to the microcomputer 15. The backlight 13c is subjected to the control of the microcomputer 15.

In the aforementioned structure, the power supply circuit 18 generates the stabilizing power to drive the inverter circuit 17 based on the power supplied from the commercial power supply in the normal state. The tube current is applied to the cold cathodes by driving the inverter circuit 17, and the illuminated cold cathodes serve to allow light emission of the backlight 13c.

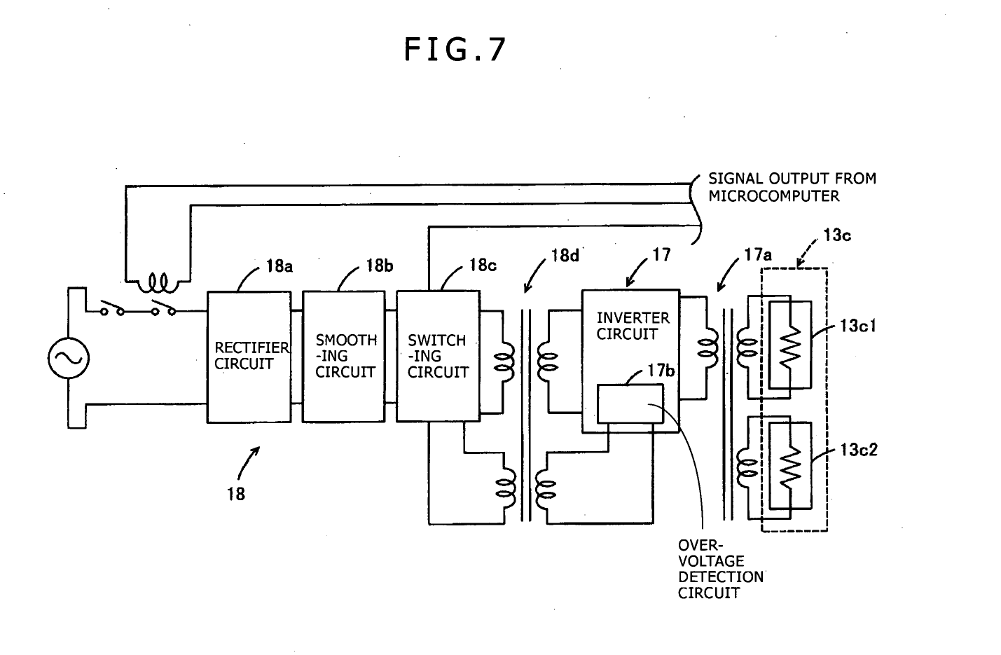

The luminance correction process according to the second embodiment of the present invention will be described referring to FIG. 7. FIG. 7 is a block diagram showing the structure of the power supply circuit as an example. Referring to the drawing, the power supply circuit 18 includes a rectifier circuit 18a for rectifying the commercial power supply, a smoothing circuit 18b for smoothing the rectified power supply, and a switching circuit 18c for generating the alternating power supply at a predetermined voltage based on the smoothed power supply In the aforementioned structure, the power supplied from the commercial power supply is converted into the dc power supply in the rectifier circuit 18a and the smoothing circuit 18b, and is further converted into the ac power supply by the switching circuit 18c so as to be supplied to the inverter circuit 17 via a transformer 18d. The switching circuit 18c drives its built-in transistor at a predetermined duty ratio so as to generate the power voltage to be supplied to the inverter circuit 17. The switching operation of the switching circuit as described above is controlled by the microcomputer 15. The duty ratio is changed by the transistor based on the control signal of the microcomputer 15 such that the predetermined voltage is generated.

The predetermined power voltage is supplied from the power supply circuit 18 to the inverter circuit 17 so as to supply power to the cold cathodes 13c1 through the transformer 17a. In the case where the failure in the voltage which has been output to the inverter circuit 17 is detected by an overvoltage detection circuit 17b built therein, the control is feed-backed to the switching circuit 18c at the power supply circuit 18 to control the drive of the power supply circuit 18.

In the aforementioned structure according to the second embodiment of the present invention, the microcomputer 15 controls the switching operation of the switching circuit 18c based on the look-up table to adjust the voltage output to the inverter circuit 17. The voltage supplied from the inverter circuit 17 to the cold cathodes 13c1 changes, thus changing the tube current applied to the cold cathodes 13c1. Then the luminance of the backlight 13c for illuminating the liquid crystal display unit 13 changes so as to be controlled.

The look-up table referred by the microcomputer 15 may be formed to store the duty ratio for generating the voltage to be supplied to the inverter circuit 17 such that the predetermined tube current is applied to the cold cathodes. Any one of the voltage value and the duty ratio may be selected to be stored in the look-up table for the convenience of the user so long as the luminance of the backlight 13c is controlled.

The flow of the routine executed by the microcomputer 15 in reference to the look-up table will be described hereinafter.

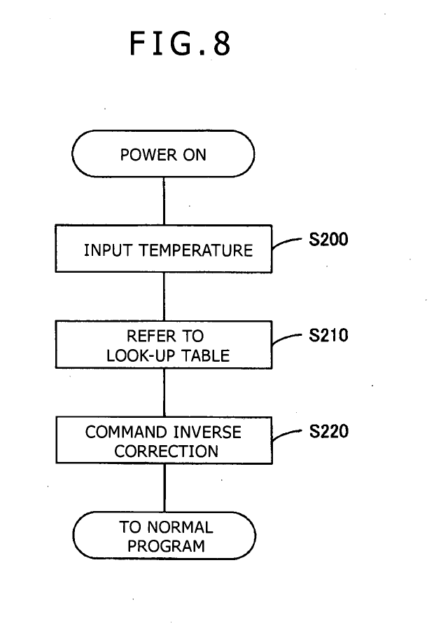

FIG. 8 is a flowchart of the luminance stabilizing program according to the second embodiment. When the power is turned ON upon the operation through the remote controller to supply power to the liquid crystal display unit 13, the microcomputer 15 makes the transition from executing the normal program to the luminance stabilizing program in reference to the ROM 16.

The microcomputer 15 first inputs the data of the temperature around the liquid crystal display unit 13 which have been output from the temperature sensor 14 (step S200). The microcomputer 15 refers to the look-up table stored in the ROM 16 (step S210) with respect to the voltage value generated by the switching circuit 18c corresponding to the temperature input from the temperature sensor 14. The microcomputer 15 has cumulatively counted the time from the moment when the power is turned ON. The voltage value corresponding to the cumulative time is used for the reference.

Based on the referred voltage value, the microcomputer 15 changes the duty ratio of the transistor in the switching circuit 18c (step S220). The switching circuit 18c generates the voltage through the switching operation at the predetermined duty ratio in response to the command of the microcomputer 15 so as to be output to the inverter circuit 17. The inverter circuit 17 amplifies the voltage through resonance, and then applies the voltage to the cold cathodes 13c1. The cold cathodes 13c1 then apply the predetermined tube current to irradiate the liquid crystal display unit 13. The backlight 13c is structured to irradiate the light with the corrected luminance to the liquid crystal display unit 13 under the control of the microcomputer 15. In this example, the voltage value is stored in the look-up table, based on which the duty ratio is changed. However, the duty ratio may be stored so long as it is kept constant for generating the same voltage value. From the aforementioned aspect, the microcomputer 15 and the ROM 16 form the tube current adjustment unit and the liquid crystal display luminance correction unit. In the embodiment, the microcomputer 15 reads the duty ratio in reference to the ROM 16. As the duty ratio, the voltage value and the tube current value each corresponding to the predetermined luminance value have predetermined correlations with one another. The tube current adjustment unit, thus, may be realized by reading either the duty ratio or the tube current value from the ROM, which has no difference therebetween.

### (4) Summary of the Second Embodiment

According to the second embodiment, the liquid crystal television 10 adjusts the tube current applied to the cold cathodes of the backlight 13c under the control of the microcomputer 15 so as to correct the luminance change of the liquid display unit 13 in the initial drive stage. This makes it possible to alleviate the discomfort felt by the viewer owing to the luminance change in the initial drive stage. In the second embodiment, the input video data are not subjected to the correction relevant to the luminance correction. Besides the aforementioned effect, this makes it possible to correct the luminance change of the liquid crystal display unit 13 in the initial drive stage while preventing degradation of the video image displayed on the liquid crystal display unit 13.

While the invention has been particularly shown and described with respect to preferred embodiments thereof, it should be understood by those skilled in the art that the foregoing and other changes in form and detail may be made therein without departing from the sprit and scope of the invention as defined in the appended claims.

It is to be understood that the present invention is not limited to the embodiments as described above, and that variances described below shall be considered as embodiments disclosed in the present invention.
A variance in which any of the members disclosed in one of the embodiments are appropriately combined with any of those disclosed in the other embodiments and exchangeable with the members.
A variance in which the members and structures disclosed in the embodiments are appropriately exchanged with those disclosed in related arts but not disclosed in the embodiments or appropriately combined with one another.
A variance in which the members and structures disclosed in the embodiments are appropriately exchanged with those thought to be substitutes by a person with ordinary skill in the art but not disclosed in the embodiments, and appropriately combined with one another.

What is claimed is:

1. A liquid crystal television, comprising:
a backlight provided with a cold cathode;
a liquid crystal display unit that displays a video image by changing a transmissivity of a light source from the backlight;
a video circuit that performs a contrast adjustment with respect to a video signal to be input;
a microcomputer that executes an entire control upon reception of an operation through a remote controller;
a Read Only Memory (ROM) that stores a program and a table, based on which the microcomputer is activated;
a temperature sensor that measures a temperature around a screen of the liquid crystal display unit; and
a time count unit that counts a time cumulatively from a moment when the liquid crystal display unit is turned ON, the ROM stores:
a look-up table that records a luminance value of the liquid crystal display unit corresponding to a cumulative time from a moment when the liquid crystal display unit is turned ON at a predetermined temperature around the screen of the liquid crystal display unit; and
a luminance correction program that allows the microcomputer to command the video circuit to correct a contrast for correcting a luminance of the video image displayed on the liquid crystal display unit in an initial drive stage thereof in reference to the luminance value stored in the look-up table corresponding to the temperature of the liquid crystal display unit measured by the temperature sensor.

2. A liquid crystal unit, including a backlight provided with a cold cathode for displaying a video image by changing a transmissivity of a light source from the backlight, and a video signal processing unit that performs an image quality adjustment of the video image displayed thereon, the liquid crystal display unit comprising:
a temperature measurement unit that measures a temperature around a screen of the liquid crystal display unit;
a time count unit that counts a time cumulatively from a moment when the liquid crystal display unit is turned ON;
a time-luminance correlation memory section that stores a luminance value of the liquid crystal display unit corresponding to a cumulative time counted from a moment when the liquid crystal display unit is turned ON at each temperature around the screen of the liquid crystal display unit; and
a liquid crystal display luminance correction unit that commands the video signal processing unit to correct a luminance of the liquid crystal display unit in reference to a record in the time-luminance correlation memory section based on the measured temperature and the counted cumulative time.

3. The liquid crystal display unit according to claim 2, wherein:
the video signal processing unit is structured to control a contrast of the video image displayed on the liquid crystal display unit; and
the liquid crystal display luminance correction unit commands the video signal processing unit to control the contrast corresponding to the counted cumulative time in reference to the time-luminance correlation memory section.

4. A liquid crystal display unit including a backlight provided with a cold cathode for changing a transmissivity of a light source from the backlight, and a backlight drive unit for generating a tube current to drive the backlight, the liquid crystal display unit comprising:
a temperature measurement unit that measures a temperature around a screen of the liquid crystal display unit;
a time count unit that counts a time cumulatively from a moment when the liquid crystal display unit is turned ON;
a time-luminance correlation memory section that stores a luminance value of the liquid crystal display unit corresponding to a cumulative time from the moment when a liquid crystal display is turned ON at each temperature around the screen of the liquid crystal display unit;
a tube current adjustment unit for controlling a value of the tube current output from the backlight drive unit to the backlight; and
a liquid crystal display luminance correction unit that outputs the tube current value to be output to the backlight to the tube current adjustment unit in reference to a record in the time-luminance correlation memory section based on the measured temperature and the counted cumulative time.

5. The liquid crystal display unit according to claim 2, wherein the microcomputer is allowed to execute a control based on an input command, and forms the liquid crystal display luminance correction unit.

6. The liquid crystal display unit according to claim 5, wherein the time-luminance correlation memory section is formed by a look-up table to be referred by the microcomputer.
